(19) United States
(12) Patent Application Publication
(10) Pub. No.: US 2021/0078696 A1
(43) Pub. Date: Mar. 18, 2021

(54) IRREGULAR SURFACE TEXTURE FOR REDUCING FLOW DRAG

(71) Applicant: Steven M. Lee, Carbondale, CO (US)

(72) Inventor: Steven M. Lee, Carbondale, CO (US)

(21) Appl. No.: 17/024,066

(22) Filed: Sep. 17, 2020

Related U.S. Application Data
(60) Provisional application No. 62/902,253, filed on Sep. 18, 2019.

(51) Int. Cl. B64C 21/10; B63B 1/36; F15D 1/00

(52) U.S. Cl. CPC B64C 21/10; B64C 2230/26; F15D 1/0035; B63B 1/36

(57) ABSTRACT

An irregular surface texture fabricated on a body which travels through fluid in order to reduce the flow drag incurred by the body moving relative to the fluid. The dominate orientation of the irregular surface texture runs in the longitudinal direction, however, ridge and valley structures may occur in any orientation so that the resulting texture mimic the turbulence characteristic present in the surrounding flow field.

### CROSS-REFERENCE TO RELATED APPLICATION

This application claims the benefit of U.S. Provisional Patent Application No. 62/902,253 filed 18 Sep. 2019 and entitled IRREGULAR SURFACE TEXTURE FOR REDUCING FLOW DRAG, the disclosure of which is incorporated, in its entirety, by this reference.

### TECHNICAL FIELD

The present disclosure relates generally to the addition of an irregular surface texture to a surface of hydrodynamic and aerodynamic bodies that result in improved flow characteristic and reduced flow drag on the body to which it is applied.

### BACKGROUND

Fluid dynamic drag on a surface may be reduced by applying a microscopic texture to an otherwise smooth surface. Riblets refer to a surface geometry or surface texture that brings about a reduction in the frictional resistance on the surface across which turbulent flow occurs. These surface geometries can be microscopic ribs which have pointy rib tips and extend along the direction of flow. The surface textures are generally regular in dimensions and pattern, usually running longitudinally in a streamwise manner. The height and riblet-to-riblet spacings are generally of the order of the dimension of the buffer layer and nearer to surface overlap layer thicknesses with typical height dimensions between 10 μm to 250 μm. Riblet structures have been utilized for example, in the aircraft industry, yacht racing, and competitive swimming.

Another familiar application of micro surface texture for drag reduction is the widespread use of dimples on golf ball. Dimples are on the order of 250 μm deep and have a uniform shape, size and spacing on the ball surface.

Application techniques include applied film, surface scarring, laser imprinting, and molding (e.g., directly formed into surface).

In the prior art, surface texture modification to otherwise smooth surfaces utilize a regular and simply repeating pattern. Repeating patterns include parallel pluralities of longitudinal riblets and evenly spaced identical dimples.

Although the exact fluid dynamic mechanism at work producing drag reduction realized from surface texture modification is not well understood, it is speculated that the reduction relates to restriction of transverse movements of the vortices in the turbulent flow.

### SUMMARY

This document presents a novel configuration of surface texture for reduction of fluid drag on bodies traveling through or on a fluid, primarily water and air. These bodies include but are not limited to airplanes, helicopters, rotor and propeller blades, cars and other wheeled vehicles, ships, boats, surfboards and other board-sport crafts, and submarines, or portions of such bodies. Additionally, the presented surface treatment relates to the internal surfaces of pipes and other fluid conduits.

The disclosed surface texture is irregular in pattern in at least one of the followings: transverse cross section, longitudinal ridge and valley heights, ridge and valley course, and plan view feature grouping pattern. The irregularity may be random and occur based on a probability of occurrence. The irregular and/or random texture occurrence in the surface texture mimics the random turbulence in the fluid through which the surface is moving resulting in a more efficient flow than over an otherwise smooth body. Utilizing irregular or random occurrence of surface pattern to mimic existing fluid turbulences is a novel and highly efficient approach to fluid drag reduction. A body or conduit that presents an irregular surface texture that is similar in structure to the turbulence pattern of the encountered flow field experience a reduction in drag in comparison to a smooth body or one comprising regular surface patterns that do not present a pattern similar to the encountered turbulence.

Additionally, irregular surface texture may be aligned to channel turbulent flow in a manner that is more efficient than channelization effected by regularly pattern riblets, dimples, or fin structures resulting in a surface that influences the flow pattern over the body in some desired manner.

For some embodiments, the median height scale of surface texture is of the order of the middle height of the overlap layer in boundary layer theory as measured from the body's low point of surface. Median ridge-to-ridge separation distances in some embodiments is about, for example, 2 to 5 times the median ridge height. This is substantially larger than height and width scales in the existing prior art. This increased height is provided to capture, for example, a kelp (Microcystis pyrifera) surface pattern without specifying the biomimicry aspect.

Some preferred embodiments exhibit surface texture on multiple scales. For instance, a primary median height scale on the order of the middle of the overlap layer and upon this scale a microscopic texture on the order of about, for example, 10 μm to 100 μm as might be produced through various manufacturing techniques such as 3D printing.

An irregular surface texture may be fabricated through any applicable technique, including but not limited to applying textured film to a surface, direct forming or molding of texture to become integral with the surface, grooving or scarring the surface, and laser burning the surface. One embodiment is the result of scanning giant kelp (Microcystis pyrifera) fronds and 3D printing resulting pattern on to a film that can be applied to a body's surface.

In some embodiments, irregular textured surface may be on both sides of a streamer or ribbon where a ridge is provided on one side and a valley on the other.

For some embodiments, the probabilistic occurrence of ridge and valley features have a high likelihood of being oriented in a longitudinal fashion, however any alignment is statistically possible. In some preferred embodiments, there is a recurring irregular pattern that is not truly random but contains enough complexity to mimic the random turbulence present in the flow field effecting the body's surface. The disclosed invention is effective in both conditions where turbulence is caused primarily from the buildup of the turbulent boundary layer alone in an otherwise uniform freestream and where there is an additive preexisting turbulence in the surrounding flow field.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label.

FIG. 1 is a schematic projection illustrating a body traveling through fluid with irregular surface texture over a portion of the body's surface in accordance with the present disclosure.

FIG. 2 is a schematic projection illustrating an irregular surface texture in accordance with the present disclosure.

FIGS. 3A-E show various irregular surface texture transverse cross sections in accordance with the present disclosure.

FIGS. 4A-D show various irregular surface texture longitudinal (streamwise) cross sections in accordance with the present disclosure.

FIGS. 5A-E show various irregular surface texture plan view ridge and valley alignments in accordance with the present disclosure.

FIGS. 6A-D show various irregular surface texture plan view ridge and valley line grouping types in accordance with the present disclosure.

FIGS. 7A-C show various surface texture with multiple texture scale irregularities including transverse cross section, longitudinal (streamwise) cross sections, and plan view of ridgelines, in accordance with the present disclosure.

FIG. 8 shows a reference cartesian coordinate system in accordance with the present disclosure.

FIG. 9 illustrates ridge to valley height and ridge-to-ridge width in accordance with the present disclosure.

FIG. 10 illustrates ridge and/or valley length in accordance with the present disclosure.

FIG. 11 illustrates theoretical regions and development stages of a boundary layer in accordance with the present disclosure.

FIG. 12 is a flow diagram showing steps of an example method in accordance with the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present disclosure describes new configurations of surface texture for bodies that travels through or on fluid that reduce flow drag and include flow in pipes and other types of fluid conduits. Additionally, the surface treatments and related methods of making the same disclosed herein may be utilized to channelize flow over or through a body in a desired fashion.

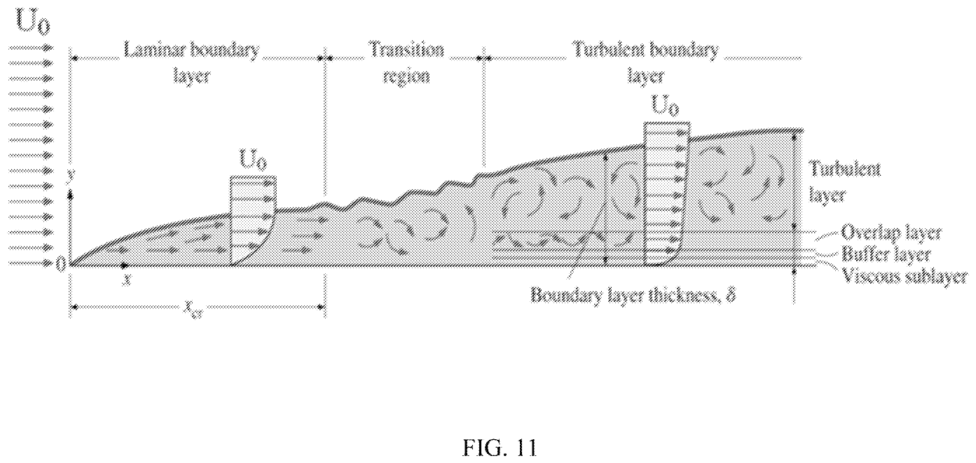

Several mechanisms by which small scale surface textures reduce drag and change flow characteristics by effecting the boundary layer structure have been suggested in scholarly literature. However, the detailed mechanisms are not clearly understood. An idealized representation of boundary layer structure is presented in FIG. 11.

For the purposes of this disclose, fully developed turbulent boundary layers are of primary concern. Non-dimensional wall units are commonly utilized in boundary layer theory in order to define scale relative to the appropriate Reynolds number. Within a turbulent boundary layer there are four identified layers. The viscous sublayer is a thin layer of laminar flow close to the surface, y+<5; and dominated by viscous forces. The Buffer Layer is between 5<y+<30 where viscous forces remain dominate but turbulence is present. In the overlap layer both viscous forces and inertial turbulent forces are mutually present. These three layers, viscous sublayer, buffer layer, and overlap layer makeup the inner region which is generally taken to be about 15% (y=0.15 δ) the overall boundary layer thickness at that downstream location. The majority of shear stress forces acting on a body moving in a fluid are the result of fluid deformations within the inner region of the boundary layer, particularly within the viscous sublayer and buffer layer. Outside the inner region is the outer region where fully developed turbulent forces are dominate.

As an illustrative example, at a point on a surfboard one meter downstream from flow inception traveling at about 2 meters per second in saltwater (20° C.) the value of y+=1 is about 7 μm. Therefore, the viscous sublayer is about 0 to 35 μm in height; the buffer layer extends from about 35 μm to 210 μm, and the overlap layer extends from about 210 μm to 2400 μm. The turbulent boundary layer extends to about 16000 μm (16 mm).

While this type of analysis in academic in nature, it is instructive as a backdrop to surface texture scale and adjusting scale from one Reynolds Number regime to another.

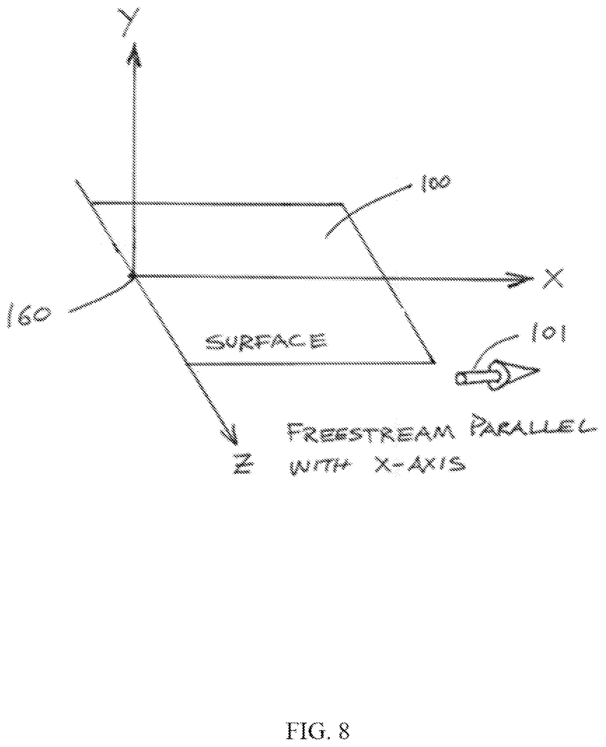

Reference Coordinate System (e.g. relative to surface of observation—see FIG. 8)
X axis—streamwise direction of the right-hand Cartesian coordinate
Y axis—perpendicular to surface righthand rule
Z axis—transverse (spanwise) to freestream flow direction on surface, righthand rule.

Nomenclature
Irregular—A surface texture that is non-uniform in pattern which may or may not repeat in occurrence. May be irregular in relation to one or more characteristic dimensions (height, spacing, streamwise length, etc.).
Random—A surface texture defined by a definite probability of occurrence of various surface elements. Does not repeat in any determinist fashion. May be random in relation to one or more characteristic dimensions (height, spacing, streamwise length, etc.).
Regular—A surface texture with a pattern that repeats at easily defined intervals. (height, spacing, streamwise length, etc.).
h—Surface texture height
h+—Non-dimensional surface texture height (Reynolds Number Similitude)=h u*/v
s—Surface texture spanwise spacing, z direction
s+—Non-dimensional surface texture spanwise spacing (Reynolds Number Similitude)=hu*/v
l—Surface texture streamwise length
l+—Non-dimensional surface texture streamwise length (Reynolds Number Similitude)=l u*/v
Rex—Reynolds number based on downstream location (u X/v)
u—Free stream velocity
u*—Shear velocity (x direction)—(Often approximated as 5% to 10% of u)
δ—Turbulent boundary layer thickness=0.38 X/(Rex**0.2) (Empirical)
v—Kinematic viscosity
ρ—Fluid density

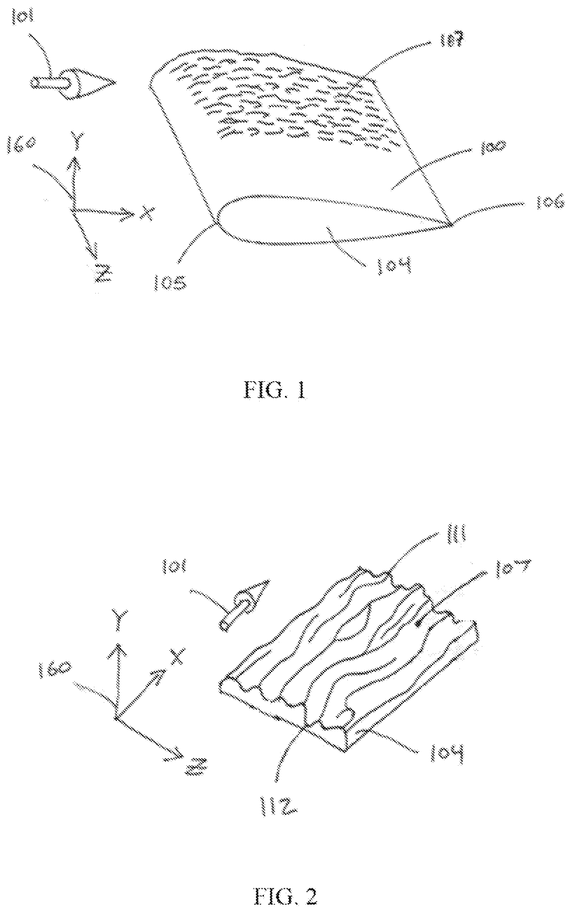

FIG. 1 shows one or more irregular textured surfaces 107 can be manifested on the surface 100 of a body 104 that experiences fluid motion 101 over its surface. FIG. 1 refers to a wing to exemplify the body 104 with a leading edge 105 and a trailing edge 106. Although a wing is depicted, it is recognized that the invention is readily adaptable to other hydrodynamic and aerodynamic surfaces as well. A cartesian coordinate system 160 is provided for reference purposes.

FIG. 2 illustrates a preferred embodiment of an irregular surface texture 107 for reducing flow drag comprised of generally longitudinally oriented ridges 111 and valleys 112 constructed on a body 104 traveling through fluid. The ridges 111 and valleys 112 have a generally elongate shape with a greater length in the X direction than a width in the Z direction or a height in the Y direction.

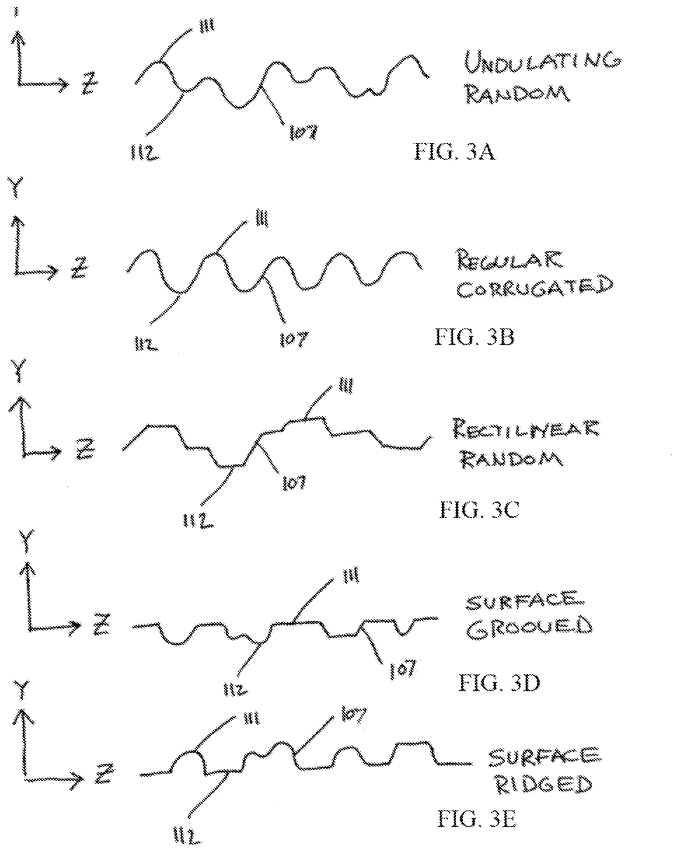

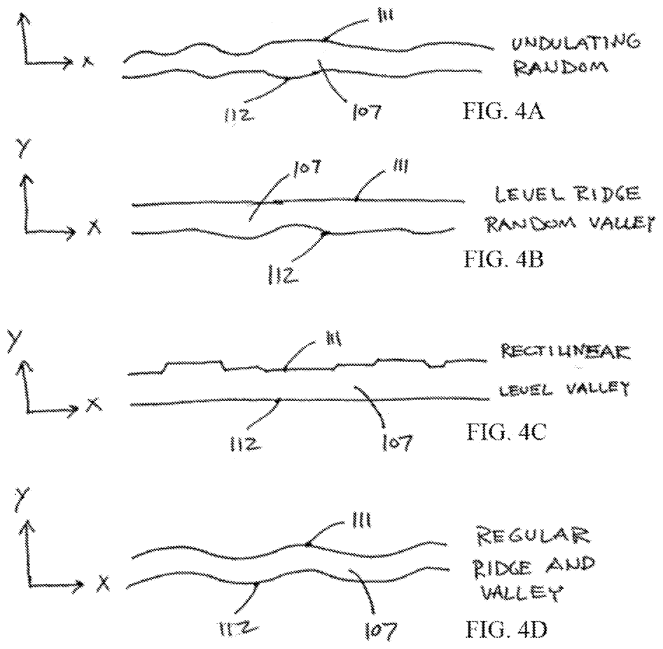

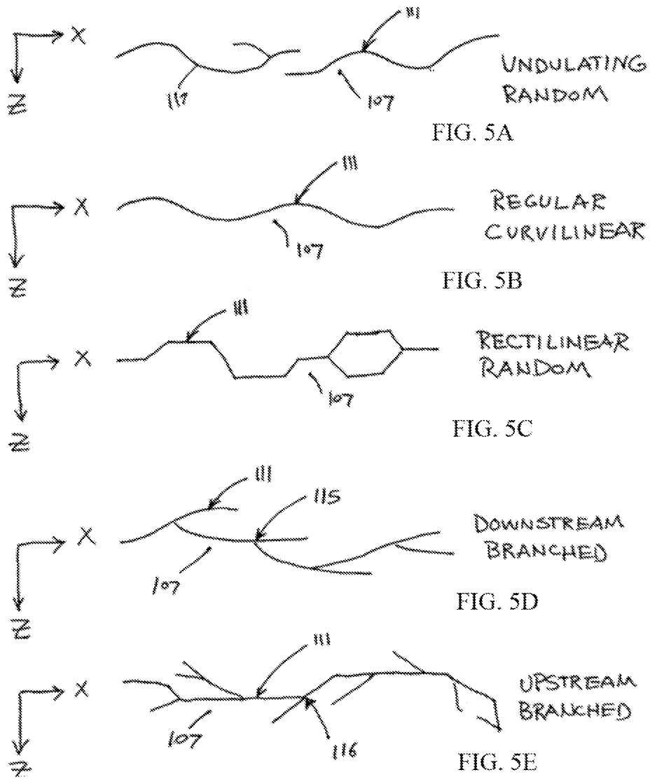

In FIG. 3, various exemplary transverse to flow direction cross sections are presented comprised of ridges 111 and valleys 112 forming an irregular textured surface 107. The five examples are not exhaustive with many other possible cross sections used to create an irregular textured surface. In FIG. 3b, regular corrugated is not irregular, but is included because it may be combined with an irregular pattern in another dimension, longitudinal (side view) or plan view. While various embodiments may be regular in one or more dimensions, they must contain irregularity in at least one dimension in order to mimic the surrounding flow turbulence (see FIG. 11).

In FIG. 4, various ridge and valley lines (side view) are illustrated. FIG. 4d shows a regular pattern, but when combined with an irregularity from another dimension will result in an overall irregular texture.

FIG. 5 illustrates various ridge 111 and valley 112 alignments. In FIG. 5a, the ridge 111 is discontinuous. FIG. 5d shows a downstream opening ridge branch 115, while FIG. 5e shows an upstream opening branch 116. Geometries presented for ridges 111 are also applicable to valleys 112.

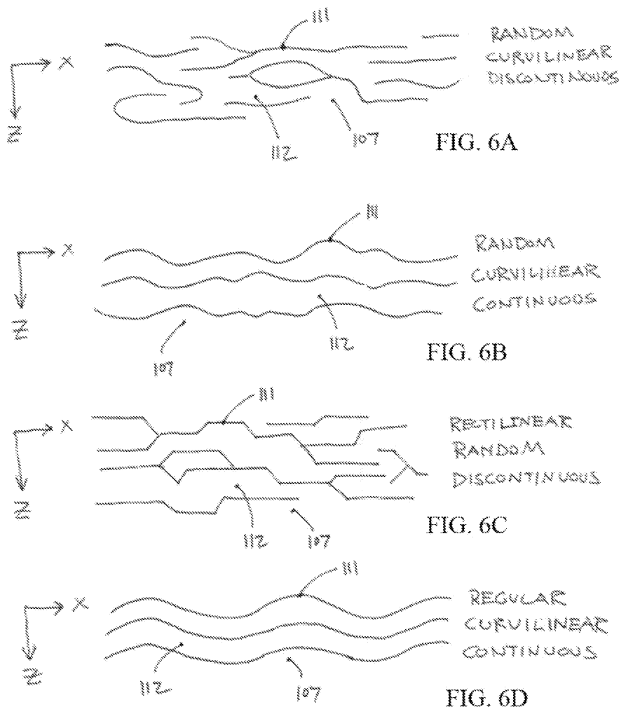

FIG. 6 depicts embodiments of various ridge 111 and valley 112 grouping styles that create irregular textured surfaces 107.

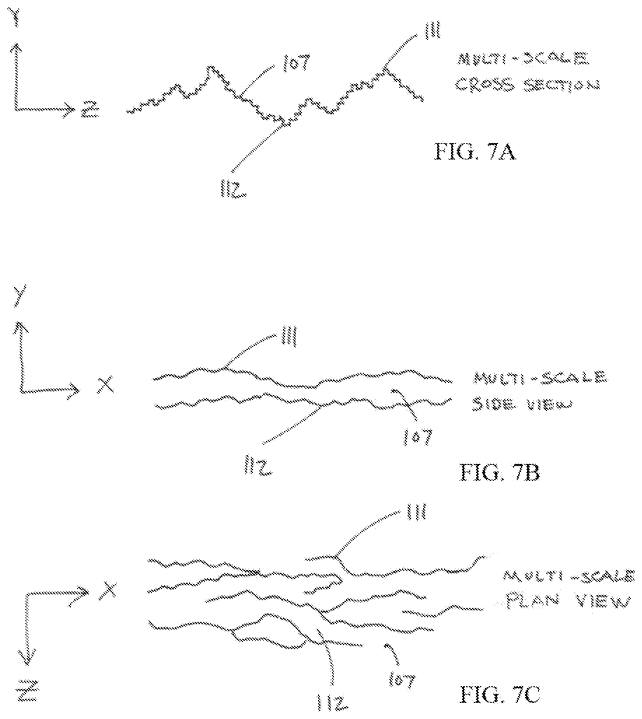

As illustrated in FIG. 7, irregular textured surfaces 107 may comprise of textures at differing scale, where there is a smaller scale surface texture upon a larger scale surface texture. In some instances, this would occur from the larger surface being created through a 3D printing process. The irregular textured surface may have similarities to the surface of giant kelp (Microcystis pyrifera). In one example, the giant kelp pattern can be scanned and 3D printed onto a film or directly on to a surface body to create the surface 107 or other of the surface textures disclosed herein. Alternatively, the scanned pattern could be integrally formed into the body surface.

FIG. 8 shows a reference cartesian coordinate system 160 in relationship to surface 100 experiencing a fluid flow 101.

As shown in FIG. 9 the valley 112 to ridge 111 height is represented by the letter h in absolute terms and h+ in dimensionless relation to Reynolds number, wall units. Wall units are utilized in fluid dynamics to relate scale to flow regime characteristics. One embodiment is designed to mimic giant kelp (Microcystis pyrifera) texture has a median height on the order of about 1000 μm (1 mm) and a median ridge 111 to ridge 111 span, s of about 4000 μm (4 mm). If demined desirable, wall unit analysis could be utilized to rescale pattern to a differing flow velocity and/or fluid viscosity.

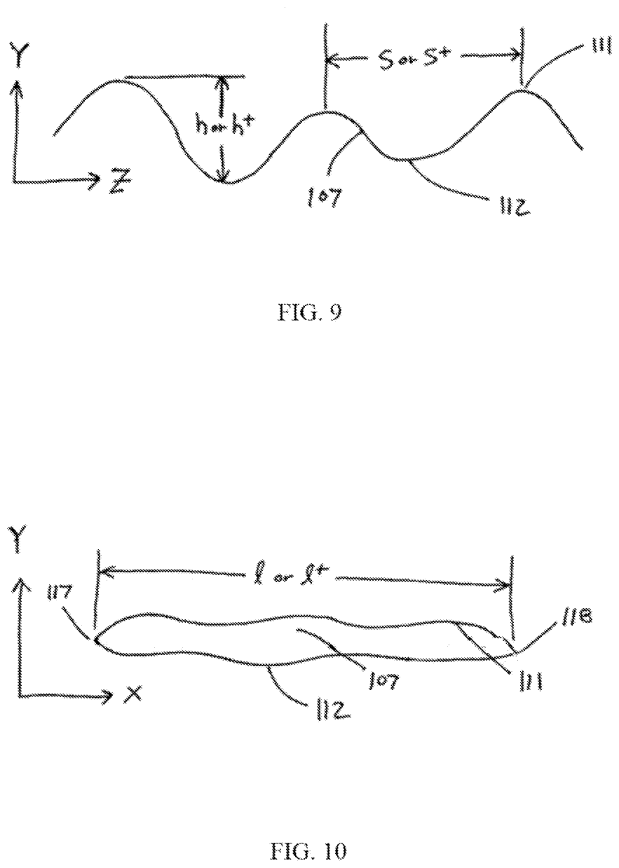

FIG. 10 illustrates the longitudinal surface texture length in absolute terms (1) and wall units (1+).

FIG. 11 depicts an idealized boundary layer where regions of development are illustrated moving left to right, moving down stream and differing layer types within the turbulent boundary layer. In one embodiment of the present disclosure, irregular surface texture has h and h+ values corresponding to a height above the valley corresponding to a location in the lower to middle of the overlap layer. At this scale, the irregular surface texture interacts with the turbulent boundary layer in a manner that reduces flow drag and efficiently channelizes the flow over the surface.

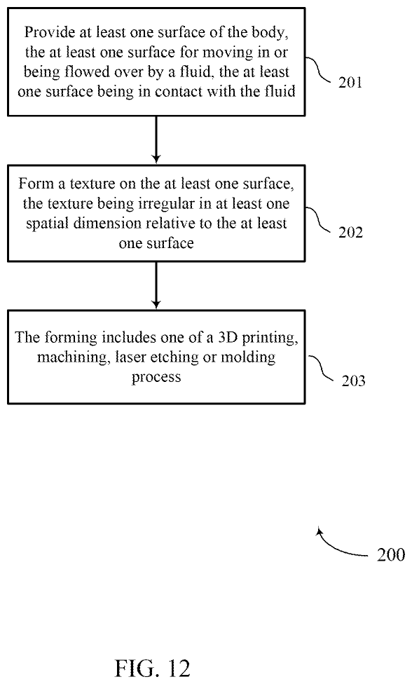

FIG. 12 is a flow diagram illustrating an example method 200 of forming a body to be exposed to a fluid flow. The method 200 may represent one or more steps applicable to operation of any one of the prosthetic devices and/or adaptors described above with reference to FIGS. 1-11. For example, the steps of method 200 may reflect formation of any of the bodies and texture configurations described above with reference to FIGS. 1-11. While several method steps associated with method 200 are shown in FIG. 12, other variations of related methods of forming a body to be exposed to a fluid flow in accordance with the present disclosure may include more or fewer steps than those shown in FIG. 12.

At 201, the method 200 includes providing at least one surface of the body, the at least one surface for moving in or being flowed over by a fluid, the at least one surface being in contact with the fluid. At 202, the method includes forming a texture on the at least one surface, the texture being irregular in at least one spatial dimension relative to the at least one surface. At 203, the forming includes one of a 3D printing, machining, laser etching, or molding process.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A body comprising:
at least one surface for moving in or being flowed over by a fluid, the at least one surface being in contact with the fluid;
a texture positioned on the at least one surface, the texture being irregular in at least one spatial dimension relative to the at least one surface.

2. The body of claim 1, wherein the texture irregularity includes at least one of an irregular shape, irregular size, and irregular spacing.

3. The body of claim 1, wherein the texture mimics a random surface texture found on giant kelp (Microcystis pyrifera) fronds.

4. The body of claim 1, wherein the texture has a greater length than a width or a thickness.

5. The body of claim 1, wherein the texture includes a plurality of irregular shaped elongate structures arranged side-by-side.

6. The body of claim 1, wherein a cross-section of the texture taken in a direction perpendicular to a direction of flow of the fluid includes a variable height.

7. A body comprising:
at least one surface for moving in or being flowed over by a fluid, the at least one surface being in contact with the fluid;
a texture positioned on the at least one surface, the texture having at least one of a random shape, random size, and random spacing in at least one spatial dimension relative to the at least one surface.

8. The body of claim 7, wherein the texture randomness includes at least one of a random shape, random size, and random spacing.

9. A body comprising:
at least one surface for moving in or being flowed over by a fluid, the at least one surface being in contact with the fluid;
a texture positioned on the at least one surface, the texture including a height scale corresponding to height of a middle portion of an overlap layer in boundary layer theory as measured from the at least one surface as a low point.

10. The body of claim 9, wherein the at least one surface defines a low point in the boundary layer theory.

11. A body comprising:
at least one surface for moving in or being flowed over by a fluid, the at least one surface being in contact with the fluid;
a texture positioned on the at least one surface, the texture structured to include multiple texture scales coexisting within a common surface composition.

12. A method of forming a body to be exposed to a fluid flow, comprising:
providing at least one surface of the body, the at least one surface for moving in or being flowed over by a fluid, the at least one surface being in contact with the fluid;
forming a texture on the at least one surface, the texture being irregular in at least one spatial dimension relative to the at least one surface;
wherein the forming includes one of a 3D printing, machining, laser etching, or molding process.
